(19) United States
(12) Patent Application Publication
(10) Pub. No.: US 2021/0058612 A1
(43) Pub. Date: Feb. 25, 2021

(54) VIRTUAL REALITY DISPLAY METHOD, DEVICE, SYSTEM AND STORAGE MEDIUM

(71) Applicants: Beijing BOE Optoelectronics Technology Co., Ltd., Beijing (CN); BOE Technology Group Co., Ltd., Beijing (CN)

(72) Inventors: Yukun Sun, Beijing (CN); Shuo Zhang, Beijing (CN); Jinghua Miao, Beijing (CN); Wenyu Li, Beijing (CN); Zhifu Li, Beijing (CN); Mingyang Yan, Beijing (CN); Qingwen Fan, Beijing (CN); Huidong He, Beijing (CN); Hao Zhang, Beijing (CN); Lili Chen, Beijing (CN)

(73) Assignees: Beijing BOE Optoelectronics Technology Co., Ltd.; BOE Technology Group Co., Ltd.

(21) Appl. No.: 16/937,678

(22) Filed: Jul. 24, 2020

(30) Foreign Application Priority Data
Aug. 21, 2019 (CN) 201910775571.5

(51) Int. Cl. H04N 13/398; H04N 13/344; H04N 13/373; H04N 13/376

(52) U.S. Cl. CPC H04N 13/398; H04N 13/344; H04N 2013/0096; H04N 13/376; H04N 13/373

(57) ABSTRACT

Disclosed are a virtual reality display method, a device, a system, and a storage medium. The method is applicable to a terminal in the virtual reality display system which includes a virtual reality device and a terminal. The method includes: rendering a first virtual reality image at a first rendering resolution to acquire a first rendered image; sending the first rendered image to the virtual reality device; rendering a second virtual reality image at a second rendering resolution to acquire a second rendered image; and sending the second rendered image to the virtual reality device, wherein the first rendering resolution is less than the second rendering resolution, and the first and the second virtual reality images are two adjacent frames of images.

This application claims priority to Chinese Patent Application 201910775571.5, filed on Aug. 21, 2019 and entitled “VIRTUAL REALITY DISPLAY METHOD, DEVICE, SYSTEM AND STORAGE MEDIUM”, the entire contents of which are incorporated herein by reference.

### TECHNICAL FIELD

The present disclosure relates to a virtual reality display method, a device, a system, and a storage medium.

### BACKGROUND

The virtual reality (VR) technology is a high and new technology that has emerged in recent years. It uses computer hardware, software and sensors to establish a virtual reality environment, which enables users to experience and interact with the virtual world by VR devices. A VR display system includes a terminal and a VR device. The terminal renders an image and sends the rendered image to the VR device, and the VR device displays the rendered image.

### SUMMARY

The present disclosure provides a virtual reality display method, a device, a system, and a storage medium. The technical solutions of the present disclosure are as follows:

In a first aspect, a virtual reality display method which is applied to a terminal in a virtual reality display system is provided, wherein the virtual reality display system includes a virtual reality device and the terminal, and the method includes:

rendering a first virtual reality image at a first rendering resolution to acquire a first rendered image;

sending the first rendered image to the virtual reality device;

rendering a second virtual reality image at a second rendering resolution to acquire a second rendered image, wherein the first rendering resolution is less than the second rendering resolution, and the first and the second virtual reality images are two adjacent frames of images; and

sending the second rendered image to the virtual reality device.

Optionally, rendering the first virtual reality image at the first rendering resolution includes:

rendering an entire area of the first virtual reality image at the first rendering resolution; and

rendering the second virtual reality image at the second rendering resolution includes:

rendering a target area of the second virtual reality image at the second rendering resolution, wherein the target area is a part of the second virtual reality image.

Optionally, before sending the second rendered image to the virtual reality device, the method further includes:

black-filling a non-target area of the second rendered image, wherein the non-target area of the second rendered image corresponds to a non-target area of the second virtual reality image, and the non-target area of the second virtual reality image is an area other than the target area in the second virtual reality image.

Optionally, before rendering the target area of the second virtual reality image at the second rendering resolution, the method further includes:

acquiring a fixation field of view of a user wearing the virtual reality device; and

determining a target area of the second virtual reality image according to the fixation field of view.

Optionally, acquiring the fixation field of view of the user wearing the virtual reality device includes:

acquiring coordinates of a fixation point of the user wearing the virtual reality device based on an eye tracking technology; and

determining the fixation field of view according to the coordinates of the fixation point;

determining the target area of the second virtual reality image according to the fixation field of view includes:

determining a corresponding area of the fixation field of view on the second virtual reality image as the target area.

Optionally, the first rendering resolution is ½, ¼, or ⅛ of a screen resolution of the virtual reality device, and the second rendering resolution is the screen resolution of the virtual reality device.

Optionally, before rendering the first virtual reality image at the first rendering resolution, the method further includes:

acquiring first head posture information of a user wearing the virtual reality device;

acquiring the first virtual reality image according to a field of view of the virtual reality device and the first head posture information; and

before rendering the second virtual reality image at the second rendering resolution, the method further includes:

acquiring second head posture information of the user wearing the virtual reality device; and

acquiring the second virtual reality image according to the field of view of the virtual reality device and the second head posture information.

Optionally, before sending the first rendered image to the virtual reality device, the method further includes:

performing virtual reality processing on the first rendered image;

before sending the second rendered image to the virtual reality device, the method further includes:

performing virtual reality processing on the second rendered image.

Optionally, the virtual reality processing includes at least one of anti-distortion processing, anti-dispersion processing, and synchronous time warp processing.

In a second aspect, a virtual reality display device applicable to a terminal in a virtual reality display system is provided. The virtual reality display system includes the virtual reality device and the terminal, and the device includes:

a first rendering module, configured to render a first virtual reality image at a first rendering resolution to acquire a first rendered image;

a first sending module, configured to send the first rendered image to the virtual reality device;

a second rendering module, configured to render a second virtual reality image at a second rendering resolution to acquire a second rendered image, wherein the first rendering resolution is less than the second rendering resolution, and the first and the second virtual reality images are two adjacent frames of images; and

a second sending module, configured to send the second rendered image to the virtual reality device.

Optionally, the first rendering module is configured to render an entire area of the first virtual reality image at the first rendering resolution; and

the second rendering module is configured to render a target area of the second virtual reality image at the second rendering resolution, wherein the target area is a part of the second virtual reality image.

Optionally, the device further includes:

a black-filling module, configured to black-fill a non-target area of the second rendered image before the second rendered image is sent to the virtual reality device, wherein the non-target area of the second rendered image corresponds to a non-target area of the second virtual reality image, the non-target area of the second virtual reality image being an area other than the target area in the second virtual reality image.

Optionally, the device further includes:

a first acquiring module, configured to acquire a fixation field of view of a user wearing the virtual reality device before a target area of the second virtual reality image is rendered at the second rendering resolution; and

a determining module, configured to determine the target area of the second virtual reality image according to the fixation field of view.

Optionally, the first acquiring module is configured to:

acquire coordinates of a fixation point of the user wearing the virtual reality device based on an eye tracking technology; and

determine the fixation field of view according to the coordinates of the fixation point;

wherein

the determining module is configured to determine a corresponding area of the fixation field of view on the second virtual reality image as the target area.

Optionally, the first rendering resolution is ½, ¼, or ⅛ of a screen resolution of the virtual reality device, and the second rendering resolution is the screen resolution of the virtual reality device.

Optionally, the device further includes:

a second acquiring module, configured to acquire first head posture information of a user wearing the virtual reality device before a first virtual reality image is rendered at a first rendering resolution; and

a third acquiring module, configured to acquire the first virtual reality image according to a field of view of the virtual reality device and the first head posture information;

a fourth acquiring module, configured to acquire second head posture information of the user wearing the virtual reality device before the second virtual reality image is rendered at the second rendering resolution; and

a fifth acquiring module, configured to acquire the second virtual reality image according to the field of view of the virtual reality device and the second head posture information.

Optionally, the device further includes:

a first processing module, configured to perform virtual reality processing on the first rendered image before the first rendered image is sent to the virtual reality device; and

a second processing module, configured to perform virtual reality processing on the second rendered image before the second rendered image is sent to the virtual reality device.

Optionally, the virtual reality processing includes at least one of anti-distortion processing, anti-dispersion processing, and synchronous time wrap processing.

In a third aspect, a virtual reality display device is provided. The device includes: a processor and a memory, wherein

the memory is configured to store a computer program; and

the processor is configured to execute the computer program stored in the memory to perform the following steps:

rendering a first virtual reality image at a first rendering resolution to acquire a first rendered image;

sending the first rendered image to the virtual reality device;

rendering a second virtual reality image at a second rendering resolution to acquire a second rendered image, wherein the first rendering resolution is less than the second rendering resolution, and the first and the second virtual reality images are two adjacent frames of images; and

sending the second rendered image to the virtual reality device.

Optionally, rendering the first virtual reality image at the first rendering resolution includes:

rendering an entire area of the first virtual reality image at the first rendering resolution; and

rendering the second virtual reality image at the second rendering resolution includes:

rendering a target area of the second virtual reality image at the second rendering resolution, wherein the target area is a part of the second virtual reality image.

Optionally, the step further includes:

black-filling a non-target area of the second rendered image before the second rendered image is sent to the virtual reality device, wherein the non-target area of the second rendered image corresponds to a non-target area of the second virtual reality image, and the non-target area of the second virtual reality image is an area other than the target area in the second virtual reality image.

Optionally, the processor is further configured to perform the following steps:

acquiring a fixation field of view of a user wearing the virtual reality device before a target area of the second virtual reality image is rendered at the second rendering resolution;

and

determining a target area of the second virtual reality image according to the fixation field of view.

Optionally, acquiring the fixation field of view of the user wearing the virtual reality device includes:

acquiring coordinates of a fixation point of the user wearing the virtual reality device based on an eye tracking technology; and

determining the fixation field of view according to the coordinates of the fixation point; wherein

determining the target area of the second virtual reality image according to the fixation field of view includes:

determining a corresponding area of the fixation field of view on the second virtual reality image as the target area.

Optionally, the first rendering resolution is ½, ¼, or ⅛ of a screen resolution of the virtual reality device, and the second rendering resolution is the screen resolution of the virtual reality device.

Optionally, the processor is further configured to perform the following steps:

acquiring first head posture information of the user wearing the virtual reality device before the first virtual reality image is rendered at the first rendering resolution; acquiring the first virtual reality image according to the field of view of the virtual reality device and the first head posture information;

acquiring second head posture information of the user wearing the virtual reality device before the second virtual reality image is rendered at the second rendering resolution;

and acquiring the second virtual reality image according to the field of view of the virtual reality device and the second head posture information.

Optionally, the processor is further configured to perform the following steps:

performing virtual reality processing on the first rendered image before the first rendered image is sent to the virtual reality device; and

performing virtual reality processing on the second rendered image before the second rendered image is sent to the virtual reality device.

Optionally, the virtual reality processing includes at least one of anti-distortion processing, anti-dispersion processing, and synchronous time warp processing.

In a fourth aspect, a virtual reality display system is provided. The system includes: a terminal and a virtual reality device, wherein

the terminal is configured to render a first virtual reality image at a first rendering resolution to acquire a first rendered image, and send the first rendered image to the virtual reality device;

the virtual reality device is configured to display the first rendered image;

the terminal is further configured to render a second virtual reality image at a second rendering resolution to acquire a second rendered image, and send the second rendered image to the virtual reality device, wherein the first rendering resolution is less than the second rendering resolution, and the first and the second virtual reality images are two adjacent frames of images; and

the virtual reality device is further configured to display the second rendered image.

Optionally, the terminal is configured to:

render an entire area of the first virtual reality image at the first rendering resolution;

and

render a target area of the second virtual reality image at the second rendering resolution, wherein the target area is a part of the second virtual reality image.

Optionally, the terminal is further configured to black-fill a non-target area of the second rendered image before the second rendered image is sent to the virtual reality device, wherein the non-target area of the second rendered image corresponds to a non-target area of the second virtual reality image, the non-target area of the second virtual reality image being an area other than the target area in the second virtual reality image.

Optionally, the terminal is further configured to:

acquire a fixation field of view of a user wearing the virtual reality device before a target region of the second virtual reality image is rendered at the second rendering resolution;

and

determine a target area of the second virtual reality image according to the fixation field of view.

Optionally, the terminal is configured to:

acquire coordinates of a fixation point of the user wearing the virtual reality device based on an eye tracking technology;

determine the fixation field of view according to the coordinates of the fixation point;

and

determine a corresponding area of the fixation field of view on the second virtual reality image as the target area.

Optionally, the first rendering resolution is ½, ¼, or ⅛ of a screen resolution of the virtual reality device, and the second rendering resolution is the screen resolution of the virtual reality device.

Optionally, the terminal is further configured to:

acquire first head posture information of the user wearing the virtual reality device before the first virtual reality image is rendered at the first rendering resolution; acquire the first virtual reality image according to the field of view of the virtual reality device and the first head posture information;

acquire second head posture information of the user wearing the virtual reality device before the second virtual reality image is rendered at the second rendering resolution;

and acquire the second virtual reality image according to the field of view of the virtual reality device and the second head posture information.

Optionally, the terminal is further configured to:

perform virtual reality processing on the first rendered image before the first rendered image is sent to the virtual reality device; and

perform virtual reality processing on the second rendered image before the second rendered image is sent to the virtual reality device.

Optionally, the virtual reality processing includes at least one of anti-distortion processing, anti-dispersion processing, and synchronous time warp processing.

In the fifth aspect, a computer-readable storage medium storing at least one computer program therein is provided. When the at least one computer program, when run by a processor, enables the processor to perform the virtual reality display method as described in the first aspect or an optional solution in the first aspect.

In a sixth aspect, a computer program product including at least one computer-executable instruction is provided. The at least one computer-executable instruction is stored in a computer-readable storage medium. The at last one computer-executable instruction, when read, loaded and executed by a processor of a computing device from the computer-readable storage medium, enables the computing device to perform the virtual reality display method as described in the first aspect or an optional solution in the first aspect.

In the seventh aspect, a chip is provided. The chip includes a programmable logic circuit and/or at least one program instruction configured to perform the virtual reality display method as described in the first aspect or an optional solution in the first aspect when the chip is in operation.

### BRIEF DESCRIPTION OF DRAWINGS

FIG. 1 is a schematic diagram of an implementation environment related to an embodiment of the present disclosure;

FIG. 2 is a flowchart of an image rendering method according to an embodiment of the present disclosure;

FIG. 3 is a flowchart of another image rendering method according to an embodiment of the present disclosure;

FIG. 4 is a schematic diagram of a grid image of a first rendered image in a screen coordinate system according to an embodiment of the present disclosure;

FIG. 5 is a schematic diagram of a grid image of a first rendered image in a field of view coordinate system according to an embodiment of the present disclosure;

FIG. 6 is a schematic diagram of a screen grid image of a first rendered image according to an embodiment of the present disclosure;

FIG. 7 is a schematic diagram of a field of view grid image of a first rendered image according to an embodiment of the present disclosure;

FIG. 8 is a schematic diagram of a first rendered image according to an embodiment of the present disclosure;

FIG. 9 is a flowchart of a method for acquiring a fixation field of view of a user according to an embodiment of the present disclosure;

FIG. 10 is a schematic diagram of a black-filled second rendered image according to an embodiment of the present disclosure;

FIG. 11 is a logical block diagram of a virtual reality display device according to an embodiment of the present disclosure;

FIG. 12 is a logical block diagram of another virtual reality display device according to an embodiment of the present disclosure;

FIG. 13 is a structural diagram of a virtual reality display device according to an embodiment of the present disclosure; and

FIG. 14 is a schematic diagram of a virtual reality display system according to an embodiment of the present disclosure.

### DESCRIPTION OF EMBODIMENTS

For clearer descriptions of the principles, technical solutions and advantages in the present disclosure, the implementation of the present disclosure is described in detail below in combination with the accompanying drawings.

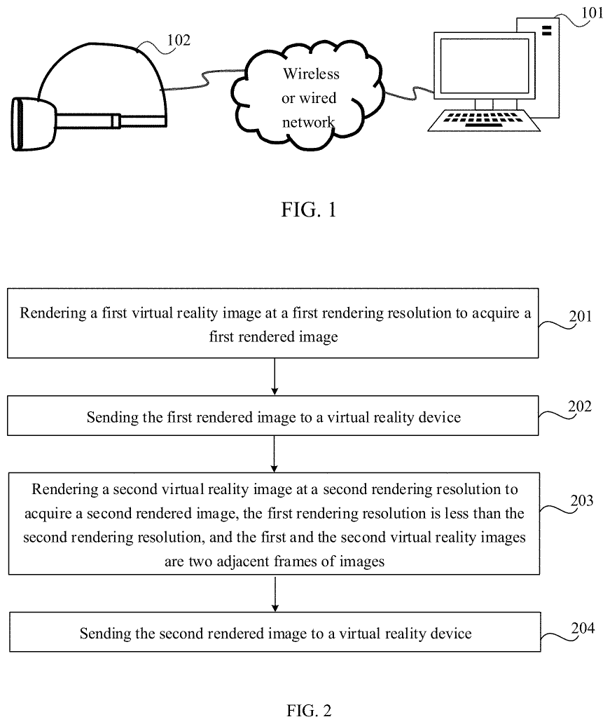

FIG. 1 is a schematic diagram of an implementation environment related to an embodiment of the present disclosure. The implementation environment involves a virtual reality display system. As shown in FIG. 1, the virtual reality display system includes a terminal 101 and a virtual reality device 102. The terminal 101 is communicatively connected to the virtual reality device 102 over a wired or wireless network. For example, the wired network is universal serial bus (USB), and the wireless network is wireless-fidelity (Wi-Fi), data, Bluetooth, ZigBee, or the similar, which is not limited in the embodiments of the present disclosure.

The terminal 101 may be a smart phone, a tablet computer, a notebook computer, a desktop computer, or the like. The virtual reality device 102 may be a head-mounted display device, such as a pair of VR glasses or a VR helmet. The virtual reality device 102 is provided with a posture sensor which may collect head posture information of a user wearing the virtual reality device 102. The posture sensor is a high-performance three-dimensional motion posture measuring device based on a micro-electro-mechanical system (MEMS) technology, and the device usually includes auxiliary motion sensors such as a three-axis gyroscope, a three-axis accelerometer and a three-axis electronic compass. The posture sensor uses these auxiliary motion sensors to collect posture information.

In the embodiment of the present disclosure, the terminal 101 renders the first virtual reality image at the first rendering resolution to acquire the first rendered image, and sends the first rendered image to the virtual reality device 102, such that the virtual reality device 102 displays the first rendered image. The terminal 101 renders the second virtual reality image at the second rendering resolution to acquire the second rendered image, and sends the second rendered image to the virtual reality device 102, such that the virtual reality device 102 displays the second rendered image. The first rendering resolution is less than the second rendering resolution, and the first and the second virtual reality images are two adjacent frames of images, that is, the terminal may render one of the two adjacent frames of images at a low rendering resolution, and render the other of the two adjacent frames of images at a high rendering resolution instead of rendering each of the frames of images at a high rendering resolution. Therefore, it helps to reduce the rendering workload of the graphics card of the terminal.

FIG. 2 is a flowchart of an image rendering method according to an embodiment of the present disclosure. The method may be used for the terminal 101 in the implementation environment shown in FIG. 1. As shown in FIG. 2, the method may include the following steps.

In step 201, a first virtual reality image is rendered at a first rendering resolution to acquire a first rendered image.

In step 202, the first rendered image is sent to the virtual reality device.

After receiving the first rendered image, the virtual reality device may display the first rendered image.

In step 203, a second virtual reality image is rendered at a second rendering resolution to acquire a second rendered image. The first rendering resolution is less than the second rendering resolution, and the first and the second virtual reality images are two adjacent frames of images.

In step 204, the second rendered image is sent to the virtual reality device.

After receiving the second rendered image, the virtual reality device may display the second rendered image.

In summary, in the virtual reality display method provided in the embodiment of the present disclosure, the terminal renders the first virtual reality image at the first rendering resolution to acquire the first rendered image, and renders the second virtual reality image at the second rendering resolution to acquire the second rendered image. The first rendering resolution is less than the second rendering resolution, and the first and the second virtual reality images are two adjacent frames of images. Because the terminal renders one of the two adjacent frames of images at a low rendering resolution, and renders the other of the two adjacent frames of images at a high rendering resolution instead of rendering each of the frames of images at a high rendering resolution, it helps to reduce the rendering workload of the graphics card of the terminal.

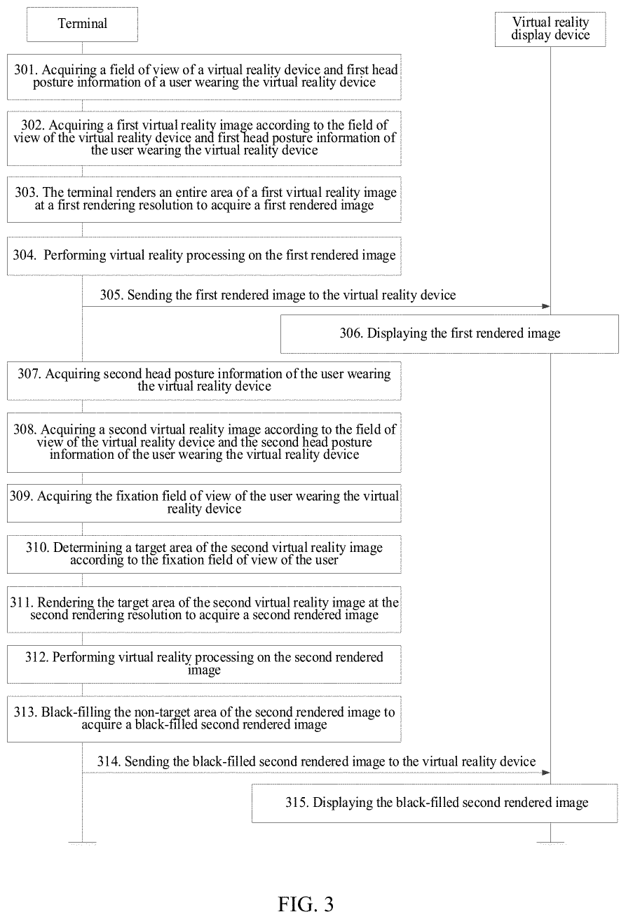

FIG. 3 is a flowchart of another image rendering method according to an embodiment of the present disclosure. The method may be used in the implementation environment shown in FIG. 1. As shown in FIG. 3, the method may include the following steps.

In step 301, the terminal acquires a field of view of the virtual reality device and first head posture information of a user wearing the virtual reality device.

Optionally, the virtual reality device may send the field of view of the virtual reality device to the terminal by a communicative connection with the terminal, and the terminal may acquire the field of view of the virtual reality device by receiving the field of view of the virtual reality device sent by the virtual reality device. Optionally, the virtual reality device may send the field of view of the virtual reality device to the terminal when the communicative connection with the terminal is established, or the terminal may send a field of view acquisition request to the virtual reality device, and the virtual reality device may send the field of view of the virtual reality device to the terminal after receiving the field of view acquisition request, which is not limited in the embodiment of the present disclosure.

Optionally, the virtual reality device may be worn on the head of a user, and the virtual reality device is provided with a posture sensor. The virtual reality device may collect the first head posture information of the user wearing the virtual reality device by the posture sensor, and send the first head posture information to the terminal by the communicative connection with the terminal. The terminal acquires the first head posture information by receiving the first head posture information sent by the virtual reality device. It is easy for those skilled in the art to understand that during the virtual reality display process, the head posture information of a user changes in real time, that the virtual reality device may collect in real time and send the head posture information of the user wearing the virtual reality device to the terminal, and that the first head posture information is the head posture information of the user wearing the virtual reality device collected in real time by the virtual reality device.

In step 302, the terminal acquires a first virtual reality image according to the field of view of the virtual reality device and first head posture information of the user wearing the virtual reality device.

Optionally, the terminal is equipped with a virtual camera, and the terminal may shoot the virtual reality scene of the terminal by the virtual camera according to the field of view of the virtual reality device and the first head posture information of the user wearing the virtual display device to acquire the first virtual reality image which may include a left-eye image and a right-eye image, such that a three-dimensional virtual reality display effect may be realized.

In the embodiment of the present disclosure, the process of shooting the virtual reality scene by the terminal by the virtual camera is processing the coordinates of an object in the virtual reality scene by the terminal. The terminal may determine a conversion matrix and a projection matrix according to the field of view of the virtual reality device and the first head posture information of the user wearing the virtual reality device, determine the coordinates of the object in the virtual reality scene according to the conversion matrix, and project the object in the virtual reality scene on a two-dimensional plane according to the coordinates of the object in the virtual reality scene and the projection matrix to acquire the first virtual reality image.

In step 303, the terminal renders an entire area of a first virtual reality image at a first rendering resolution to acquire a first rendered image.

The first rendering resolution may be less than the screen resolution of the virtual reality device. For example, the first rendering resolution is ½ (i.e., one-half), ¼ (i.e., one-quarter) or ⅛ (i.e., one-eighth) of the screen resolution of the virtual reality device, which is not limited in the embodiment of the present disclosure. For example, the screen resolution of the virtual reality device is 4K×4K (i.e., 4096×4096), the first rendering resolution is 2K×2K (i.e., 2048×2048), and the first rendering resolution is ½ of the screen resolution of the virtual reality device. Because the first rendering resolution is less than the screen resolution of the virtual reality device, rendering the entire area of the first virtual reality image by the terminal at the first rendering resolution may reduce the rendering workload of the graphics card of the terminal.

Optionally, the terminal divides the first virtual reality image into a plurality of primitives of the same size, converts each primitive into fragments by rasterization, and renders a plurality of fragments at the first rendering resolution to acquire the first rendered image.

In step 304, the terminal performs virtual reality processing on the first rendered image.

The virtual reality device includes a lens. Due to the limitation of lens design and production process, the lens has defects, which causes deformation to the image observed by human eyes by the lens, such that the image observed by human eyes by the virtual reality device is distorted. Light with different colors has different refraction angles when passing through the lens, such that the image observed by human eyes by the virtual reality device is dispersed. The head posture information of the user changes in real time. It takes time for the terminal to render the image. The head posture information at the moment of image displaying is different from the head posture information of the user at the moment of image acquiring, and thereby causing a delay in the displayed image.

In the embodiment of the present disclosure, the terminal may perform virtual reality processing on the first rendered image, and the virtual reality processing may include at least one of anti-distortion processing, anti-dispersion processing, and synchronous time warp processing. The terminal performs anti-distortion processing to the first rendered image, such that the image displayed by the virtual reality device is an anti-distortion image, and there is no distortion in the image observed by human eyes by the lens of the virtual reality device. The terminal performs anti-dispersion processing to the first rendered image, such that the image displayed by the virtual reality device is an anti-dispersion image, and there is no dispersion in the image observed by human eyes by the lens of the virtual reality device. The terminal performs synchronous time warp processing to the first rendered image, such that there is no delay in the image displayed by the virtual reality device.

Optionally, the terminal may establish a screen coordinate system and a coordinates system of the field of view of the virtual reality device. The screen coordinate system may be a plane coordinate system, with the projection point of the optical axis of the lens of the virtual reality device on the screen of the virtual reality device as an origin of coordinates, a first direction as a y-axis positive direction, and a second direction as an x-axis positive direction. The coordinate system of the field of view may be a plane coordinate system, with the center point (i.e., the intersection of the optical axis and the plane of the lens) of the lens of the virtual reality device as the origin of coordinates, a third direction as the y-axis positive direction, and a fourth direction as the x-axis positive direction. The first direction may be an upward direction with the user as the reference when the user wears the virtual reality device in a normal condition. The second direction may be a rightwards direction with the user as the reference when the user wears the virtual reality device in a normal condition. The third direction is parallel to the first direction. The fourth direction is parallel to the second direction.

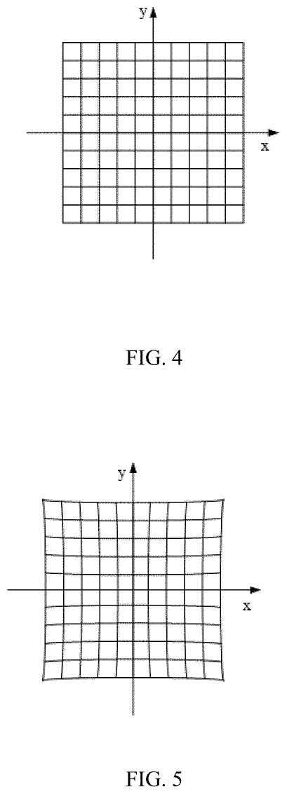

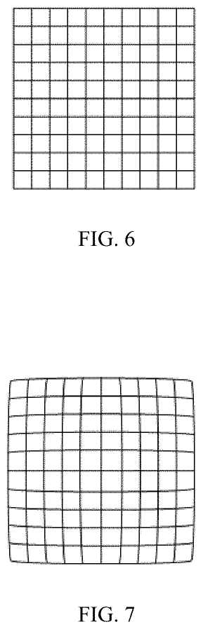

The terminal may divide the first rendered image into a plurality of rectangular primitives of the same size to acquire the screen grid image of the first rendered image (i.e., the grid image of the first rendered image in the screen coordinate system, for example, as shown in FIG. 4.), and determine the field of view grid image of the first rendered image (i.e., the grid image of the first rendered image in the coordinate system of the field of view, for example, as shown in FIG. 5) according to the screen grid image of the first rendered image. There is no distortion in the screen grid image, but there is distortion in the field of view grid image, and thus the anti-distortion processing of the first rendered image is realized. The terminal may store an anti-distortion mapping relationship. The process of determining the field of view grid image of the first rendered image according to the screen grid image of the first rendered image may include: mapping the vertex of each primitive in the screen grid image of the first rendered image by the terminal to the coordinate system of the field of view according to the coordinates and anti-distortion mapping relation of the vertex of each primitive in the screen grid image of the first rendered image, so as to acquire the field of view grid image of the first rendered image; and mapping the grayscale value of each primitive in the screen grid image of the first rendered image to the corresponding primitive in the field of view grid image of the first rendered image according to the coordinate of the vertex of each primitive in the field of view grid image of the first rendered image, so as to acquire the anti-distorted first rendered image. For example, FIG. 6 is a schematic diagram of a screen grid image of a first rendered image according to the embodiment of the present disclosure, and FIG. 7 is a schematic diagram of the field of view grid image of a first rendered image according to the embodiment of the present disclosure.

Optionally, the terminal may determine the dispersion parameter of the lens of the virtual reality device. The dispersion parameter of the lens may include the dispersion parameter of the lens to red light, the dispersion parameter of the lens to green light, and the dispersion parameter of the lens to blue light. The terminal performs anti-dispersion processing to the first rendered image by means of an anti-dispersion algorithm to acquire the anti-dispersed first rendered image.

Optionally, the terminal may perform a distortion process to the first rendered image according to the previous frame of image of the first rendered image by means of a synchronous time warp technology, so as to acquire the first rendered image after the synchronous time warp processing.

Those skilled in the art would readily understand that the anti-distortion processing, anti-dispersion processing, and synchronous time warp processing may be performed synchronously or in order to the first rendered image by the terminal. For example, the terminal first performs the anti-distortion processing to the first rendered image to acquire the anti-distorted first rendered image, and then performs anti-dispersion processing to the anti-distorted first rendered image to acquire the anti-dispersed first rendered image, and finally performs synchronous time warp processing to the anti-dispersed first rendered image; or the terminal first performs the anti-dispersion processing to the first rendered image to acquire the anti-dispersed first rendered image, and then performs the anti-distortion processing to the anti-dispersed first rendered image to acquire the anti-distorted first rendered image, and finally performs synchronous time warp processing to the anti-dispersed first rendered image, which is not limited in the embodiment of the present disclosure.

In step 305, the terminal sends the first rendered image to the virtual reality device.

After performing virtual reality processing on the first rendered image, the terminal may send the first rendered image, i.e., the first rendered image after the terminal sends virtual reality processing on the virtual reality device, to the virtual reality device.

In the embodiment of the present disclosure, as the first rendered image is an image acquired by the terminal by means of rendering the entire area of the first virtual reality image at the first rendering resolution, the resolution of the first rendered image is the first rendering resolution. As the first rendering resolution is less than the screen resolution of the virtual reality device, the resolution of the first rendered image is less than the screen resolution of the virtual reality device. Optionally, before the first rendered image is sent to the virtual reality device, the terminal may stretch the first rendered image such that the resolution of the first rendered image is equal to the resolution of the display screen of the virtual reality device. For example, the terminal performs pixel interpolation to the first rendered image such that the resolution of the first rendered image after pixel interpolation is equal to the resolution of the display screen of the virtual reality device.

In step 306, the virtual reality device displays the first rendered image.

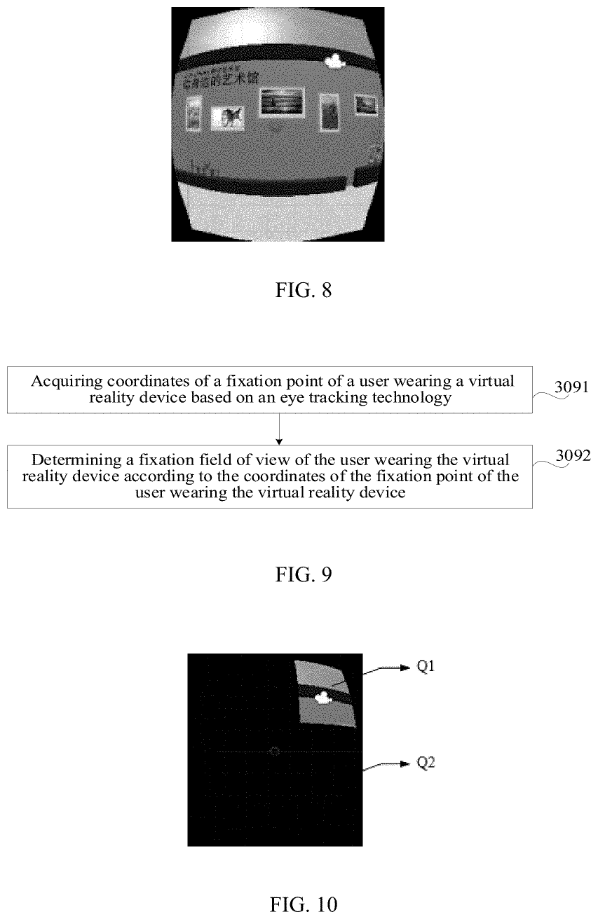

In contrast to that the terminal sends the first rendered image to the virtual reality device, the virtual reality device receives the first rendered image sent by the terminal, and then, the virtual reality device displays the first rendered image. For example, the first rendered image displayed by the virtual reality device may be as shown in FIG. 8.

In step 307, the terminal acquires second head posture information of the user wearing the virtual reality device.

Optionally, the virtual reality device may be worn on the head of a user, and the virtual reality device is provided with a posture sensor. The virtual reality device may collect the second head posture information of the user wearing the virtual reality device by the posture sensor, and send the second head posture information to the terminal by the communicative connection with the terminal. The terminal acquires the second head posture information by receiving the second head posture information sent by the virtual reality device. The second head posture information is the head posture information of the user wearing the virtual reality device collected in real time by the virtual reality device.

In step 308, the terminal acquires a second virtual reality image according to the field of view of the virtual reality device and the second head posture information of the user wearing the virtual reality device.

For the implementation process of the step 308, reference may be made to step 302, which is not repeated herein in the embodiment of the present disclosure.

In step 309, the terminal acquires the fixation field of view of the user wearing the virtual reality device.

For example, FIG. 9 is a flowchart of a method for acquiring a fixation field of view of a user wearing a virtual reality device according to an embodiment of the present disclosure. As shown in FIG. 9, the method may include the following steps.

In sub-step 3091, coordinates of a fixation point of the user wearing the virtual reality device are acquired based on an eye tracking technology.

The terminal may acquire an eye image of the user wearing the virtual reality device based on the eye tracking technology, acquire the information of pupil center and spot position (the light spot is a reflection bright spot formed by the screen of the virtual reality device on the cornea of the user) of the user based on the eye image of the user, and determine the coordinates of the fixation point according to the information of the pupil center and spot position of the user.

In sub-step 3092, the fixation field of view of the user wearing the virtual reality device is determined according to the coordinates of the fixation point of the user wearing the virtual reality device.

Optionally, the terminal may acquire the viewing angle range of the human eye based on the eye tracking technology, and determine the fixation field of view of the user wearing the virtual reality device according to the coordinates of the fixation point and the viewing angle range of the human eye. The coordinates of the fixation point may be the coordinates of the fixation point of the human eye in the field of view coordinate system.

For example, if the coordinates of the fixation point acquired by the terminal based on the eye tracking technology are (Pₓ, P_{y}), the viewing angle range of the human eye along the x-axis (for example, the horizontal viewing angle range) is h, and the viewing angle range along the y-axis (for example, the vertical viewing angle range) is v, then the terminal determines that the fixation field of view may be (P_{y}+v/2, P_{y}−v/2, Pₓ−h/2, Pₓ+h/2).

In step 310, the terminal determines a target area of the second virtual reality image according to the fixation field of view of the user.

Optionally, the target area may be a fixation area. The terminal determines the area corresponding to fixation field of view of the user on the second virtual reality image as the target area. For example, the fixation field of view of the user is (P_{y}+v/2, P_{y}−v/2, Pₓ−h/2, Pₓ+h/2), the corresponding area of the fixation field of view may be a rectangular area with vertexes being P_{y}+v/2, P_{y}−v/2, Pₓ−h/2 and Pₓ+h/2. The terminal determines the rectangular area as the target area.

In step 311, the terminal renders the target area of the second virtual reality image at the second rendering resolution to acquire a second rendered image.

The second rendering resolution may be the screen resolution of the virtual reality device. The target area is a part of the second virtual reality image. Because the terminal renders a part of the second virtual reality image, but not the entire area of the second virtual reality image, at the second rendering resolution, the rendering workload of the graphics card of the terminal can be reduced.

Optionally, the terminal may divide the target area of the second virtual reality image into a plurality of primitives of the same size, convert each primitive into fragments by rasterization, and render a plurality of fragments at the second rendering resolution to acquire the second rendered image.

In step 312, the terminal performs virtual reality processing on the second rendered image.

For the implementation process of the step 312, reference may be made to step 304, which will not be repeated here in the embodiment of the present disclosure.

In step 313, the terminal black-fills the non-target area of the second rendered image to acquire a black-filled second rendered image.

The non-target area of the second rendered image may be an area other than the target area in the second rendered image, and the target area of the second rendered image corresponds to the target area of the second virtual reality image.

Optionally, the terminal may configure the grayscale value of each pixel in the non-target area of the second rendered image to be zero, such that the pixels in the non-target area do not emit light, and thereby performing black-filling to the non-target area of the second rendered image to acquire the black-filled second rendered image.

In step 314, the terminal sends the black-filled second rendered image to the virtual reality device.

In step 315, the virtual reality device displays the black-filled second rendered image.

In contrast to that the terminal sends the black-filled second rendered image to the virtual reality device, the virtual reality device receives the black-filled second rendered image sent by the terminal, and then, the virtual reality device displays the black-filled second rendered image. For example, the black-filled second rendered image displayed by the virtual reality device may be as shown in FIG. 10. The image is displayed in the target area Q1, and the color of the non-target area Q2 is black.

In the embodiment of the present disclosure, the first and the second virtual reality images are two adjacent frames of images. The terminal renders the entire area of one of the two adjacent frames of images at a low rendering resolution, renders a part of the area of the other of the two adjacent frames of images at a high rendering resolution, and sends the two adjacent frames of images to the virtual reality device in sequence, such that the virtual reality device displays the two adjacent frames of images in sequence. In this way, the fixation point rendering effect is shown by taking advantage of the visual persistence characteristics of human eyes. The current fixation point rendering technologies include multi-resolution rendering (MRS) technology, lens matching rendering (LMS) technology, variable rate rendering (VRS) technology and the like. In the current fixation point rendering technologies, the terminal renders the fixation area (i.e., the fixation area of human eyes on the image) of the image at a high rendering resolution (for example, the screen resolution of the virtual reality device) for each frame of the image, and renders the area other than the fixation area on the image at a low rendering resolution. Because the terminal shall render the entire area of each frame of the image, the rendering workload of the graphics card of the terminal is high. However, in the embodiment of the present disclosure, the terminal renders the entire area of one of the two adjacent frames of images at a low rendering resolution, and renders a part of the other of the two adjacent frames of images at a high rendering resolution. By taking advantage of the visual persistence characteristics of human eyes, the fixation point rendering effect is presented. That is, the technical solution provided in the embodiment of the present disclosure may show the rendering effect of fixation point. Moreover, compared with the current fixation point rendering technologies, the rendering workload of the graphics card of the terminal may be reduced because the entire area of each frame of the image is not rendered.

In summary, in the virtual reality display method provided in the embodiment of the present disclosure, the terminal renders the first virtual reality image at the first rendering resolution to acquire the first rendered image, and renders the second virtual reality image at the second rendering resolution to acquire the second rendered image. The first rendering resolution is less than the second rendering resolution, and the first and the second virtual reality images are two adjacent frames of images. Because the terminal renders one of the two adjacent frames of images at a low rendering resolution, and renders the other of the two adjacent frames of images at a high rendering resolution instead of rendering each of the frames of images at a high rendering resolution, it helps to reduce the rendering workload of the graphics card.

Those skilled in the art would readily understand that the sequence of steps for the virtual reality display method according to the embodiments of the present disclosure may be adjusted appropriately, and the steps may also be added or subtracted according to the situation. Within the technical scope disclosed by the present disclosure, any variant which can be easily thought of by those skilled in the art shall be covered within the protection scope of the present disclosure, and therefore will not be repeated here.

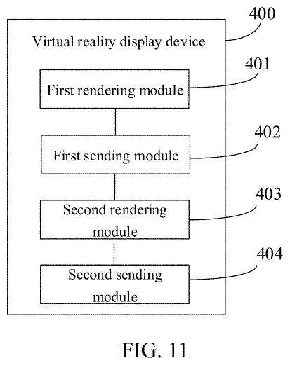

FIG. 11 is a logical block diagram of a virtual reality display device 400 according to an embodiment of the present disclosure. The virtual reality display device 400 may be a functional component in a terminal. As shown in FIG. 11, the virtual reality display device 400 may include:

a first rendering module 401, configured to render a first virtual reality image at a first rendering resolution to acquire a first rendered image;

a first sending module 402, configured to send the first rendered image to the virtual reality device;

a second rendering module 403, configured to render a second virtual reality image at a second rendering resolution to acquire a second rendered image, wherein the first rendering resolution is less than the second rendering resolution, and the first and the second virtual reality images are two adjacent frames of images; and

a second sending module 404, configured to send the second rendered image to the virtual reality device.

In summary, in the virtual reality display device provided in the embodiments of the present disclosure, the first rendering module renders the first virtual reality image at the first rendering resolution to acquire the first rendered image, and the first sending module sends the first rendered image to the virtual reality device; the second rendering module renders the second virtual reality image at the second rendering resolution to acquire the second rendered image, and the second sending module sends the second rendered image to the virtual reality device; wherein the first rendering resolution is less than the second rendering resolution, and the first and the second virtual reality images are two adjacent frames of images. Because one of the two adjacent frames of images is rendered at a low rendering resolution and the other of the two adjacent frames of images is rendered at a high rendering resolution (but not each of the frames of images is rendered at a high rendering resolution), it helps to reduce the rendering workload of the graphics card of the terminal.

Optionally, the first rendering module 401 is configured to render an entire area of the first virtual reality image at the first rendering resolution; and

the second rendering module 403 is configured to render a target area of the second virtual reality image at the second rendering resolution, wherein the target area is a part of the second virtual reality image.

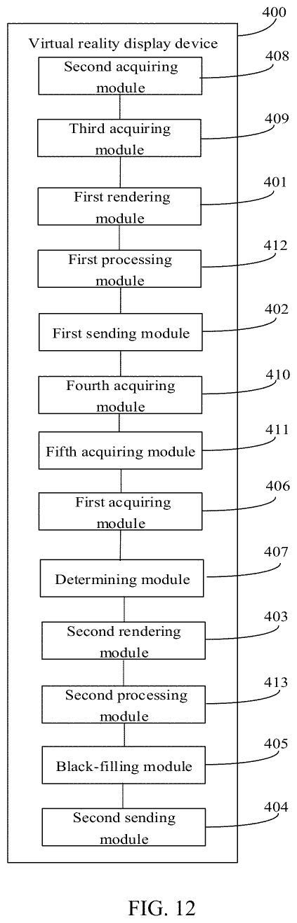

Optionally, referring to FIG. 12 which shows a logical block diagram of another virtual reality display device 400 according to an embodiment of the present disclosure, the virtual reality display device 400 further includes:

a black-filling module 405, configured to black-fill a non-target area of the second rendered image before the second rendered image is sent to the virtual reality device, wherein the non-target area of the second rendered image corresponds to a non-target area of the second virtual reality image, and the non-target area of the second virtual reality image is an area other than the target area in the second virtual reality image.

Optionally, please refer to FIG. 12 again, and the virtual reality display device 400 further includes:

a first acquiring module 406, configured to acquire a fixation field of view of a user wearing the virtual reality device before a target area of the second virtual reality image is rendered at the second rendering resolution; and

a determining module 407, configured to determine a target area of the second virtual reality image according to the fixation field of view.

Optionally, the first acquiring module 406 is configured to:

acquire coordinates of a fixation point of the user wearing the virtual reality device based on an eye tracking technology; and

determine the fixation field of view according to the coordinates of the fixation point;

wherein

the determining module 407 is configured to determine a corresponding area of the fixation field of view on the second virtual reality image as the target area.

Optionally, please refer to FIG. 12 again, and the virtual reality display device 400 further includes:

Optionally, please refer to FIG. 12 again, and the virtual reality display device 400 further includes:

a second acquiring module 408, configured to acquire first head posture information of a user wearing the virtual reality device before a first virtual reality image is rendered at a first rendering resolution; and

a third acquiring module 409, configured to acquire the first virtual reality image according to a field of view of the virtual reality device and the first head posture information;

and

a fourth acquiring module 410, configured to acquire second head posture information of the user wearing the virtual reality device before the second virtual reality image is rendered at the second rendering resolution; and

a fifth acquiring module 411, configured to acquire the second virtual reality image according to the field of view of the virtual reality device and the second head posture information of the user wearing the virtual reality device;

Optionally, please refer to FIG. 12 again, and the virtual reality display device 400 further includes:

a first processing module 412, configured to perform virtual reality processing on the first rendered image before the first rendered image is sent to the virtual reality device; and

a second processing module 413, configured to perform virtual reality processing on the second rendered image before the second rendered image is sent to the virtual reality device.

Optionally, the virtual reality processing includes at least one of anti-distortion processing, anti-dispersion processing, and synchronous time warp processing.

In summary, in the virtual reality display device provided in the embodiments of the present disclosure, the first rendering module renders the first virtual reality image at the first rendering resolution to acquire the first rendered image, and the first sending module sends the first rendered image to the virtual reality device; the second rendering module renders the second virtual reality image at the second rendering resolution to acquire the second rendered image, and the second sending module sends the second rendered image to the virtual reality device; wherein the first rendering resolution is less than the second rendering resolution, and the first and the second virtual reality images are two adjacent frames of images. Because one of the two adjacent frames of images is rendered at a low rendering resolution and the other of the two adjacent frames of images is rendered at a high rendering resolution (but not each of the frames of images is rendered at a high rendering resolution), it is conductive to reducing the rendering workload of the graphics card of the terminal.

With regard to the devices in the above embodiments, the way the respective modules perform the operations has been described in detail in the embodiment relating to the method, which is not described herein any further.

An embodiment of the present disclosure provides a virtual reality display device including a processor and a memory, wherein

the memory is configured to store a computer program, and

the processor is configured to execute the computer program stored in the memory to perform any of the methods as shown in FIGS. 2, 3 and 9.

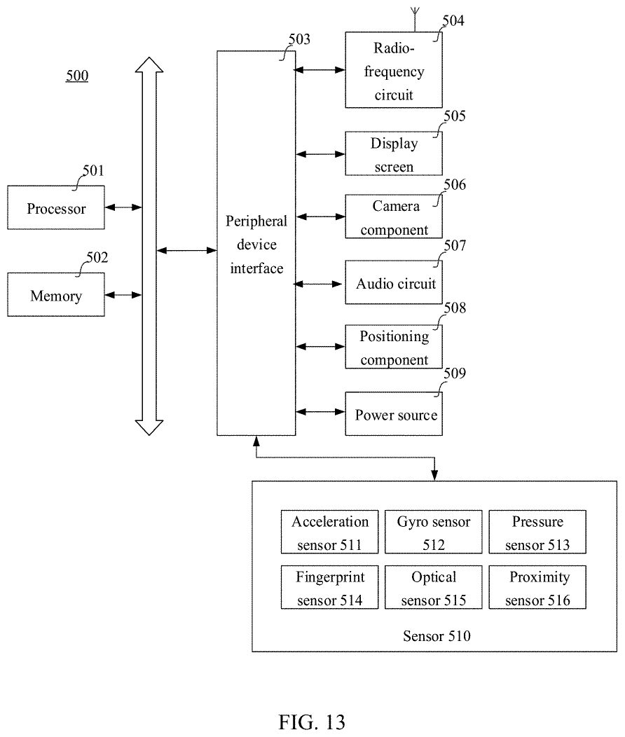

For example, FIG. 13 is a structural block diagram of a virtual reality display device 500 according to an embodiment of the present disclosure. The virtual reality display device 500 may be a smart phone, a tablet computer, a Moving Picture Experts Group Audio Layer III (MP3) player, a Moving Picture Experts Group Audio Layer IV (MP4) player, a laptop or desk computer. The virtual reality display device 500 may also be called a user equipment (UE), a portable terminal, a laptop terminal, a desk terminal, or the like.

Generally, the virtual reality display device 500 includes a processor 501 and a memory 502.

The processor 501 may include one or more processing cores, such as a 4-core processor and an 8-core processor. The processor 501 may be formed by at least one hardware of a digital signal processor (DSP), a field-programmable gate array (FPGA), and a programmable logic array (PLA). The processor 501 may also include a main processor and a coprocessor. The main processor is a processor for processing the data in an awake state, and is also called a central processing unit (CPU). The coprocessor is a low-power-consumption processor for processing the data in a standby state. In some embodiments, the processor 501 may be integrated with a graphics processing uint (GPU), which is configured to render and draw the content that needs to be displayed by a display screen. In some embodiments, the processor 501 may also include an Artificial Intelligence (AI) processor configured to process computational operations related to machine learning.

The memory 502 may include one or more computer-readable storage mediums, which can be non-transitory. The memory 502 may also include a high-speed random-access memory, as well as a non-volatile memory, such as one or more disk storage devices and flash storage devices. In some embodiments, the non-transitory computer-readable storage medium in the memory 502 is configured to store at least one instruction. The at least one instruction is configured to be executed by the processor 501 to implement the method for playing audio data provided by the method embodiments of the present disclosure.

In some embodiments, the virtual reality display device 500 also optionally includes a peripheral device interface 503 and at least one peripheral device. The processor 501, the memory 502, and the peripheral device interface 503 may be connected by a bus or a signal line. Each peripheral device may be connected to the peripheral device interface 503 by a bus, a signal line, or a circuit board. For example, the peripheral device includes at least one of a radio frequency circuit 504, a touch display screen 505, a camera 506, an audio circuit 507, a positioning component 508 and a power source 509.

The peripheral device interface 503 may be configured to connect at least one peripheral device associated with an input/output (I/O) to the processor 501 and the memory 502. In some embodiments, the processor 501, the memory 502 and the peripheral device interface 503 are integrated on the same chip or circuit board. In some other embodiments, any one or two of the processor 501, the memory 502 and the peripheral device interface 503 may be practiced on a separate chip or circuit board, which is not limited in the present embodiment.

The radio frequency circuit 504 is configured to receive and transmit an radio frequency (RF) signal, which is also referred to as an electromagnetic signal. The radio frequency circuit 504 communicates with a communication network and other communication devices via the electromagnetic signal. The radio frequency circuit 504 converts the electrical signal into the electromagnetic signal for transmission, or converts the received electromagnetic signal into the electrical signal. Optionally, the radio frequency circuit 504 includes an antenna system, an RF transceiver, one or more amplifiers, a tuner, an oscillator, a digital signal processor, a codec chipset, a subscriber identity module card, and the like. The radio frequency circuit 504 can communicate with other terminals via at least one wireless communication protocol. The wireless communication protocol includes, but not limited to, the World Wide Web, a metropolitan area network, an intranet, various generations of mobile communication networks (2G, 3G, 4G, and 5G), a wireless local area network, and/or a Wi-Fi network. In some embodiments, the RF circuit 504 may also include near-field communication (NFC) related circuits, which is not limited in the present disclosure.

The display screen 505 is configured to display a user interface (UI). The UI may include graphics, text, icons, videos, and any combination thereof. When the display screen 505 is a touch display screen, the display screen 505 also has the capacity to acquire touch signals on or over the surface of the display screen 505. The touch signal may be input into the processor 501 as a control signal for processing. At this time, the display screen 505 may also be configured to provide virtual buttons and/or virtual keyboards, which are also referred to as soft buttons and/or soft keyboards. In some embodiments, one display screen 505 may be disposed on the front panel of the virtual reality display device 500. In some other embodiments, at least two display screens 505 may be disposed respectively on different surfaces of the virtual reality display device 500 or in a folded design. In further embodiments, the display screen 505 may be a flexible display screen disposed on the curved or folded surface of the virtual reality display device 500. Even the display screen 505 may have an irregular shape other than a rectangle; that is, the display screen 505 may be an irregular-shaped screen. The display screen 505 may be an organic light-emitting diode (OLED) screen.

The camera component 506 is configured to capture images or videos. Optionally, the camera component 506 includes a front camera and a rear camera. Usually, the front camera is placed on the front panel of the terminal, and the rear camera is placed on the back of the terminal. In some embodiments, at least two rear cameras are disposed, and are at least one of a main camera, a depth-of-field camera, a wide-angle camera, and a telephoto camera respectively, so as to realize a background blurring function achieved by fusion of the main camera and the depth-of-field camera, panoramic shooting and VR shooting functions achieved by fusion of the main camera and the wide-angle camera or other fusion shooting functions. In some embodiments, the camera component 506 may also include a flashlight. The flashlight may be a mono-color temperature flashlight or a two-color temperature flashlight. The two-color temperature flash is a combination of a warm flashlight and a cold flashlight and can be used for light compensation at different color temperatures.

The audio circuit 507 may include a microphone and a speaker. The microphone is configured to collect sound waves of users and environments, and convert the sound waves into electrical signals which are input into the processor 501 for processing, or input into the RF circuit 504 for voice communication. For the purpose of stereo acquisition or noise reduction, there may be a plurality of microphones respectively disposed at different locations of the virtual reality display device 500. The microphone may also be an array microphone or an omnidirectional acquisition microphone. The speaker is then configured to convert the electrical signals from the processor 501 or the radio frequency circuit 504 into the sound waves. The speaker may be a conventional film speaker or a piezoelectric ceramic speaker. When the speaker is the piezoelectric ceramic speaker, the electrical signal can be converted into not only human-audible sound waves but also the sound waves which are inaudible to humans for the purpose of ranging and the like. In some embodiments, the audio circuit 507 may also include a headphone jack.

The positioning component 508 is configured to locate the current geographic location of the virtual reality display device 500 to implement navigation or a location based service (LBS). The positioning component 808 may be the global positioning system (GPS) from the United States, the Beidou positioning system from China, the Grenas satellite positioning system from Russia or the Galileo satellite navigation system from the European Union.

The power source 509 is configured to power up various components in the virtual reality display device 500. The power source 509 may be alternating current, direct current, a disposable battery, or a rechargeable battery. When the power source 509 includes the rechargeable battery, the rechargeable battery may a wired rechargeable battery or a wireless rechargeable battery. The wired rechargeable battery is a battery charged by a cable line, and wireless rechargeable battery is charged by a wireless coil. The rechargeable battery may also support the fast charging technology.

In some embodiments, virtual reality display device 500 also includes one or more sensors 510. The one or more sensors 510 include, but not limited to, an acceleration sensor 511, a gyro sensor 512, a pressure sensor 513, a fingerprint sensor 514, an optical sensor 515 and a proximity sensor 516.

The acceleration sensor 511 may detect magnitudes of accelerations on three coordinate axes of a coordinate system established by the virtual reality display device 500. For example, the acceleration sensor 511 may be configured to detect components of a gravitational acceleration on the three coordinate axes. The processor 501 may control the touch display screen 505 to display a user interface in a landscape view or a portrait view according to a gravity acceleration signal collected by the acceleration sensor 511. The acceleration sensor 511 may also be configured to collect motion data of a game or a user.

The gyro sensor 512 is capable of detecting a body direction and a rotation angle of the virtual reality display device 500, and cooperating with the acceleration sensor 511 to capture a 3D motion of the user on the virtual reality display device 500. Based on the data captured by the gyro sensor 512, the processor 501 is capable of implementing the following functions: motion sensing (such as changing the UI according to a user's tilt operation), image stabilization during shooting, game control and inertial navigation.

The pressure sensor 513 may be disposed on a side frame of the virtual reality display device 500 and/or a lower layer of the touch display screen 505. When the pressure sensor 513 is disposed on the side frame of the virtual reality display device 500, a user's holding signal to the virtual reality display device 500 can be detected. The processor 501 can perform left-right hand recognition or quick operation according to the holding signal collected by the pressure sensor 513. When the pressure sensor 513 is disposed on the lower layer of the touch display screen 505, the processor 501 controls an operable control on the UI according to a user's pressure operation on the touch display screen 505. The operable control includes at least one of a button control, a scroll bar control, an icon control and a menu control.

The fingerprint sensor 514 is configured to collect a user's fingerprint. The processor 501 identifies the user's identity based on the fingerprint collected by the fingerprint sensor 514, or the fingerprint sensor 514 identifies the user's identity based on the collected fingerprint. When the user's identity is identified as trusted, the processor 501 authorizes the user to perform related sensitive operations, such as unlocking the screen, viewing encrypted information, downloading software, paying, and changing settings. The fingerprint sensor 514 may be provided on the front, back, or side of the virtual reality display device 500. When the virtual reality display device 500 is provided with a physical button or a manufacturer's logo, the fingerprint sensor 514 may be integrated with the physical button or the manufacturer's logo.

The optical sensor 515 is configured to collect ambient light intensity. In one embodiment, the processor 501 is capable of controlling the display luminance of the touch display screen 505 according to the ambient light intensity captured by the optical sensor 515. For example, when the ambient light intensity is high, the display luminance of the touch display screen 505 is increased; and when the ambient light intensity is low, the display luminance of the touch display screen 505 is decreased. In another embodiment, the processor 501 may also dynamically adjust shooting parameters of the camera component 506 according to the ambient light intensity captured by the optical sensor 515.

The proximity sensor 516, also referred to as a distance sensor, is usually disposed on the front panel of the virtual reality display device 500. The proximity sensor 516 is configured to capture a distance between the user and a front surface of the virtual reality display device 500. In one embodiment, when the proximity sensor 516 detects that the distance between the user and the front surface of the virtual reality display device 500 becomes gradually smaller, the processor 501 controls the touch display screen 505 to switch from a screen-on state to a screen-off state. When it is detected that the distance between the user and the front surface of the virtual reality display device 500 gradually increases, the processor 501 controls the touch display screen 505 to switch from the screen-off state to the screen-on state.

It will be understood by those skilled in the art that the structure shown in FIG. 13 does not constitute a limitation to the virtual reality display device 500, and may include more or less components than those illustrated, or combine some components or adopt different component arrangements.

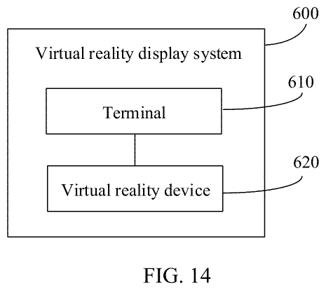

Please refer to FIG. 14 which shows a schematic diagram of a virtual reality display system 600 according to an embodiment of the present disclosure. As shown in FIG. 14, the virtual reality display system 600 includes: a terminal 610 and a virtual reality device 620. The terminal 610 is communication connected to the virtual reality device 620. The terminal 610 may include the virtual reality display device 400 as shown in FIG. 11 or FIG. 12, or the terminal 610 may include the virtual reality display device 500 as shown in FIG. 13.

Optionally, the terminal 610 is configured to render a first virtual reality image at a first rendering resolution to acquire a first rendered image, and send the first rendered image to the virtual reality device 620;

the virtual reality device 620 is configured to display the first rendered image;

the terminal 610 is further configured to render a second virtual reality image at a second rendering resolution to acquire a second rendered image, and send the second rendered image to the virtual reality device 620, wherein the first rendering resolution is less than the second rendering resolution, and the first and the second virtual reality images are two adjacent frames of images; and

the virtual reality device 620 is further configured to display the second rendered image.

Optionally, the terminal 610 is configured to:

render an entire area of the first virtual reality image at the first rendering resolution;

and

render a target area of the second virtual reality image at the second rendering resolution, wherein the target area is a part of the second virtual reality image.

Optionally, the terminal 610 is further configured to: black-fill the non-target area of the second rendered image before the second rendered image is sent to the virtual reality device 620, wherein the non-target area of the second rendered image corresponds to the non-target area of the second virtual reality image, and the non-target area of the second virtual reality image is an area other than the target area in the second virtual reality image.

Optionally, the terminal 610 is further configured to:

acquire a fixation field of view of a user wearing the virtual reality device 620 before a target area of the second virtual reality image is rendered at the second rendering resolution; and

determine the target area of the second virtual reality image according to the fixation field of view.

Optionally, the terminal 610 is configured to:

acquire coordinates of a fixation point of the user wearing the virtual reality device 620 based on the eye tracking technology;

determine the fixation field of view according to the coordinates of the fixation point; and

determine a corresponding area of the fixation field of view on the second virtual reality image as the target area.

Optionally, the first rendering resolution is ½, ¼, or ⅛ of a screen resolution of the virtual reality device 620, and the second rendering resolution is the screen resolution of the virtual reality device 620.

Optionally, the terminal 610 is further configured to:

acquire first head posture information of the user wearing the virtual reality device 620 before the first virtual reality image is rendered at the first rendering resolution; acquire the first virtual reality image according to the field of view of the virtual reality device 620 and the first head posture information; and

acquire second head posture information of the user wearing the virtual reality device 620 before the second virtual reality image is rendered at the second rendering resolution;

and acquire the second virtual reality image according to the field of view of the virtual reality device 620 and the second head posture information.

Optionally, the terminal 610 is further configured to:

perform virtual reality processing on the first rendered image before the first rendered image is sent to the virtual reality device 620; and

perform virtual reality processing on the second rendered image before the second rendered image is sent to the virtual reality device 620.

Optionally, the virtual reality processing includes at least one of anti-distortion processing, anti-dispersion processing, and synchronous time distortion processing.

An embodiment of the present disclosure provides a computer-readable storage medium storing at least one program therein. The at least one program, when run by a processor, enables the processor to perform the virtual reality display method as shown in any of FIGS. 2, 3 and 9.

An embodiment of the present disclosure provides a computer program product including at least one computer-executable instruction therein. The at last one computer-executable instruction is stored in a computer-readable storage medium. The at least one computer-executable instruction, when read, loaded and executed by a processor of a computing device, enables the computing device to perform the virtual reality display method as shown in any of FIGS. 2, 3 and 9.

An embodiment of the present disclosure provides a chip which includes a programmable logic circuit and/or at least one program instruction. The chip is configured to perform the virtual reality display method as shown in any of FIGS. 2, 3, and 9 when the chip is in operation.

Those skilled in the art can understand that all or part of the steps of implementing the above embodiments may be completed by hardware, or may be completed by related hardware instructed by a program, and the program may be stored in a computer-readable storage medium. The storage medium mentioned above may be a read-only memory, a magnetic disk or an optical disk or the like.

In the present disclosure, the terms “first”, “second”, “third” and “fourth” are for descriptive purposes only and are not to be construed as indicating or implying relative importance. The term “a plurality of” refers to two or more, unless otherwise specifically defined. In addition, the term “and/or” in the present disclosure is merely configured to describe association relations among associated objects, and may indicate three relationships. For example, “A and/or B” may indicate that A exists alone, or A and B exist simultaneously, or B exists alone.

Described above are merely exemplary embodiments of the present disclosure, and are not intended to limit the present disclosure. Within the spirit and principles of the disclosure, any modifications, equivalent substitutions, improvements, and the like are within the protection scope of the present disclosure.

What is claimed is:

1. A virtual reality display method applicable to a terminal in a virtual reality display system, wherein the virtual reality display system comprises a virtual reality device and the terminal, and the method comprises:
rendering a first virtual reality image at a first rendering resolution to acquire a first rendered image;
sending the first rendered image to the virtual reality device;
rendering a second virtual reality image at a second rendering resolution to acquire a second rendered image, wherein the first rendering resolution is less than the second rendering resolution, and the first and the second virtual reality images are two adjacent frames of images; and
sending the second rendered image to the virtual reality device.

2. The method according to claim 1, wherein
rendering the first virtual reality image at the first rendering resolution comprises:
rendering an entire area of the first virtual reality image at the first rendering resolution; and
rendering the second virtual reality image at the second rendering resolution comprises:
rendering a target area of the second virtual reality image at the second rendering resolution, wherein the target area is a part of the second virtual reality image.

3. The method according to claim 2, wherein before sending the second rendered image to the virtual reality device, the method further comprises:
black-filling a non-target area of the second rendered image, wherein the non-target area of the second rendered image corresponds to a non-target area of the second virtual reality image, the non-target area of the second virtual reality image being an area other than the target area in the second virtual reality image.

4. The method according to claim 2, wherein before rendering the target area of the second virtual reality image at the second rendering resolution, the method further comprises:
acquiring a fixation field of view of a user wearing the virtual reality device; and
determining the target area of the second virtual reality image according to the fixation field of view.

5. The method according to claim 4, wherein
acquiring the fixation field of view of the user wearing the virtual reality device comprises:
acquiring coordinates of a fixation point of the user wearing the virtual reality device based on an eye tracking technology; and
determining the fixation field of view according to the coordinates of the fixation point; and
determining the target area of the second virtual reality image according to the fixation field of view comprises:
determining a corresponding area of the fixation field of view on the second virtual reality image as the target area.

6. The method according to claim 1, wherein the first rendering resolution is ½, ¼, or ⅛ of a screen resolution of the virtual reality device, and the second rendering resolution is the screen resolution of the virtual reality device.

7. The method according to claim 1, wherein
before rendering the first virtual reality image at the first rendering resolution, the method further comprises:
acquiring first head posture information of a user wearing the virtual reality device;
acquiring the first virtual reality image according to a field of view of the virtual reality device and the first head posture information; and
before rendering the second virtual reality image at the second rendering resolution, the method further comprises:
acquiring second head posture information of the user wearing the virtual reality device; and
acquiring the second virtual reality image according to the field of view of the virtual reality device and the second head posture information.

8. The method according to claim 1, wherein
before sending the first rendered image to the virtual reality device, the method further comprises:
performing virtual reality processing on the first rendered image; and
before sending the second rendered image to the virtual reality device, the method further comprises:
performing virtual reality processing on the second rendered image.

9. The method according to claim 8, wherein the virtual reality processing comprises at least one of anti-distortion processing, anti-dispersion processing, and synchronous time warp processing.

10. A virtual reality display device, comprising: a processor and a memory, wherein
the memory is configured to store at least one computer program; and
the processor is configured to run the at least one computer program stored in the memory to perform the following steps:
rendering a first virtual reality image at a first rendering resolution to acquire a first rendered image;
sending the first rendered image to the virtual reality device;
rendering a second virtual reality image at a second rendering resolution to acquire a second rendered image, wherein the first rendering resolution is less than the second rendering resolution, and the first and the second virtual reality images are two adjacent frames of images; and
sending the second rendered image to the virtual reality device.

11. The device according to claim 10, wherein
rendering the first virtual reality image at the first rendering resolution comprises:
rendering an entire area of the first virtual reality image at the first rendering resolution; and
rendering the second virtual reality image at the second rendering resolution comprises:
rendering a target area of the second virtual reality image at the second rendering resolution, wherein the target area is a part of the second virtual reality image.

12. The device according to claim 11, wherein the processor is further configured to perform the following steps:
black-filling a non-target area of the second rendered image before the second rendered image is sent to the virtual reality device, wherein the non-target area of the second rendered image corresponds to a non-target area of the second virtual reality image, the non-target area of the second virtual reality image being an area other than the target area in the second virtual reality image.

13. The device according to claim 11, wherein the processor is further configured to perform the following steps:
acquiring a fixation field of view of a user wearing the virtual reality device before the target area of the second virtual reality image is rendered at the second rendering resolution; and
determining the target area of the second virtual reality image according to the fixation field of view.

14. The device according to claim 13, wherein
acquiring the fixation field of view of the user wearing the virtual reality device comprises:
acquiring coordinates of a fixation point of the user wearing the virtual reality device based on an eye tracking technology; and
determining the fixation field of view according to the coordinates of the fixation point; and
determining the target area of the second virtual reality image according to the fixation field of view comprises:
determining a corresponding area of the fixation field of view on the second virtual reality image as the target area.

15. The device according to claim 10, wherein
the first rendering resolution is ½, ¼, or ⅛ of a screen resolution of the virtual reality device, and the second rendering resolution is the screen resolution of the virtual reality device.

16. The device according to claim 10, wherein the processor is further configured to perform the following steps:
acquiring first head posture information of a user wearing the virtual reality device before the first virtual reality image is rendered at the first rendering resolution; acquiring the first virtual reality image according to a field of view of the virtual reality device and the first head posture information; and
acquiring second head posture information of the user wearing the virtual reality device before the second virtual reality image is rendered at the second rendering resolution; and acquiring the second virtual reality image according to the field of view of the virtual reality device and the second head posture information.

17. The device according to claim 10, wherein the processor is further configured to perform the following steps:
performing virtual reality processing on the first rendered image before the first rendered image is sent to the virtual reality device; and
performing virtual reality processing on the second rendered image before the second rendered image is sent to the virtual reality device.

18. The device according to claim 17, wherein the virtual reality processing comprises at least one of anti-distortion processing, anti-dispersion processing, and synchronous time wrap processing.

19. A virtual reality display system, comprising: a terminal and a virtual reality device, wherein
the terminal is configured to render a first virtual reality image at a first rendering resolution to acquire a first rendered image, and send the first rendered image to the virtual reality device;
the virtual reality device is configured to display the first rendered image;
the terminal is further configured to render a second virtual reality image at a second rendering resolution to acquire a second rendered image, and send the second rendered image to the virtual reality device, wherein the first rendering resolution is less than the second rendering resolution, and the first and the second virtual reality images are two adjacent frames of images; and
the virtual reality device is further configured to display the second rendered image.

20. A storage medium storing at least one computer program therein, wherein the at least one computer program, when run by a processor, enables the processor to perform the virtual reality display method as defined in claim 1.
